(19) United States
(12) Patent Application Publication
(10) Pub. No.: US 2012/0247588 A1
(43) Pub. Date: Oct. 4, 2012

(54) FLOW RATE STABILIZER

(76) Inventor: Tsai-Chen YANG, Taichung City (TW)

(21) Appl. No.: 13/073,272

(22) Filed: Mar. 28, 2011

(51) Int. Cl. F15D 1/00

(52) U.S. Cl. 137/560

(57) ABSTRACT

A flow rate stabilizer of the present invention includes a main body and an elastic ring. The main body is formed with a receiving groove and a plurality of penetrating holes. The elastic ring is movably received in the receiving groove. The position of the elastic ring is able to be changed by water pressure so as to obstruct water flow partially. Au such, flow rate is stabilized. Structure of the flow rate stabilizer is simplified, so that producibility and durability of the present invention is well performed.

### BACKGROUND OF THE INVENTION

1. Field of the Invention

The present invention relates to a flow rate stabilizer, which is provided for fresh water pipe to make the flow rate stabilized.

2. Description of the Prior Art

Conventional flow rate stabilizer, as disclosed in TW I338756, is provided for faucet, shower nozzle, or the like, being installed in the flow way. The stabilizer has an elastic member for pushing a slidable plunger. When the water pressure of the water supply is increased, the plunger is pushed by water. The plunger is then moved to obstruct the flow way partially. As such, increment of flow rate is slashed even the water pressure is suddenly increased. When the water pressure of the water supply is decreased, the plunger is pushed by the elastic member. The plunger is then moved forward to open the flow way. As such, decrement of flow rate is minimized. The flow rate is stabilized overall.

However, the structure the flow rate stabilizer is complicated. The stabilizer is composed of an amount of components. Thus, the stabilizer is difficult to be produced and to be fabricated.

Another flow rate stabilizer, as disclosed in U.S. Pat. No. 7,392,828, is also provided for water pipe and the like. The stabilizer in 828' has an elastic valve which partially obstructs in the flow way. When the water pressure is changed, the valve is bent to open or close the flow way. As such, flow rate is stabilized. Further, the stabilizer has less components so that the stabilizer can be produced easily.

However, using the valve still brings some deficiencies in. The flow rate stabilizer in 828' should be fabricated with the valve. The valve should be formed with a special structure. That is, manufacturing of the valve tend to be difficult. Secondly, figure of the valve would significantly affect the stabilization result. To avoid the valve block the flow way totally or develop without obstruction, the valve should be produced precisely. As a result, manufacturing difficulties are pushed up. Thirdly, after using for a long time, the valve would be bent back and forth again and again. Material of the valve would be fatigue. Lifetime of the stabilizer is limited.

The present invention is, therefore, arisen to obviate or at least mitigate the above mentioned disadvantages.

### SUMMARY OF THE INVENTION

The main object of the present invention is to provide a flow rate stabilizer which has a simplified structure and a lengthened lifetime.

To achieve the above and other objects, a flow rate stabilizer of the present invention includes a main body and an elastic ring.

The main body has a top surface and a bottom surface. The main body is formed with an annular guiding wall, an annular abutting wall, and an annular bottom wall. An annular receiving groove is defined by the guiding wall, the abutting wall, and the bottom wall. The receiving groove extends axially from the top surface. The receiving groove has an opening. The guiding wall extends conically from the opening to the bottom wall. The abutting wall extends axially form the opening to the bottom wall. A radial distance defined between the guiding wall and the abutting wall is decreased toward the bottom wall. The main body is formed with a plurality of penetrating holes. Each penetrating hole extends axially. Each penetrating hole communicates axially with the receiving groove. At least a part of a figure of each penetrating hole covers a figure of the guiding wall axially.

The elastic ring is received in the receiving groove. The elastic ring abuts the guiding wall. The elastic ring is movable between a first position and a second position along the guiding wall. The elastic ring is adjacent to the opening when the elastic ring is located at the first position. The elastic ring abuts against the bottom wall when the elastic ring is located at the second position. The elastic ring has a tendency to move to the first position.

In some different cases, a diameter of the guiding wall may larger or smaller than that of the abutting wall.

In some cases, the bottom wall has an arc-shaped cross section. The elastic ring fits with the bottom wall when the elastic ring is located at the second position.

In some cases, the guiding wall has an outline which is adjacent to the opening touches tangentially with outlines of the penetrating holes.

In some cases, each penetrating hole has a figure covering both figure of the guiding wall and figure of the bottom wall.

As such, the elastic ring is able to move in the receiving groove so as to obstruct the flow way partially making the flow rate stabilized. The structure of the main body and the structure of elastic ring are simplified. As such, manufacturing is uncomplicated, and lifetime is prolonged.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a shower nozzle in where the flow rate stabilizer of the present invention can be assembled;

FIG. 2 is partial cross sectional drawing of FIG. 1;

FIG. 3 is a break down drawing showing a first embodiment of the present invention;

FIG. 4 is a front view showing a main body of a first embodiment of the present invention;

FIG. 5 is a stereogram showing a main body of a first embodiment of the present invention;

FIG. 6 is a cross sectional drawing showing a first embodiment of the present invention;

FIG. 7 is a partial cross sectional drawing showing a first embodiment of the present invention;

FIG. 8 is a partial cross sectional drawing showing a using state of a first embodiment of the present invention;

FIG. 9 is a partial cross sectional drawing showing a using state of a first embodiment of the present invention;

FIG. 10 is a cross sectional drawing showing a second embodiment of the present invention.

### DETAILED DESCRIPTION OF THE PREFERRED EMBODIMENTS

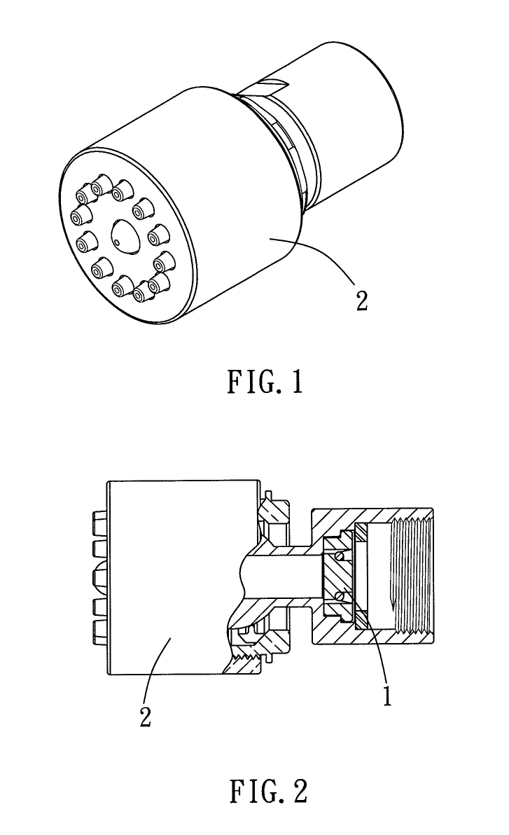

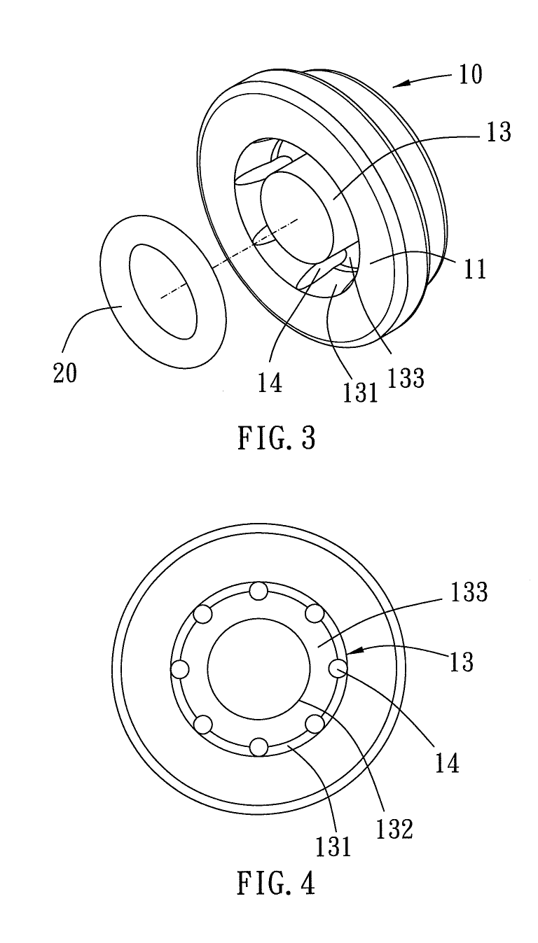

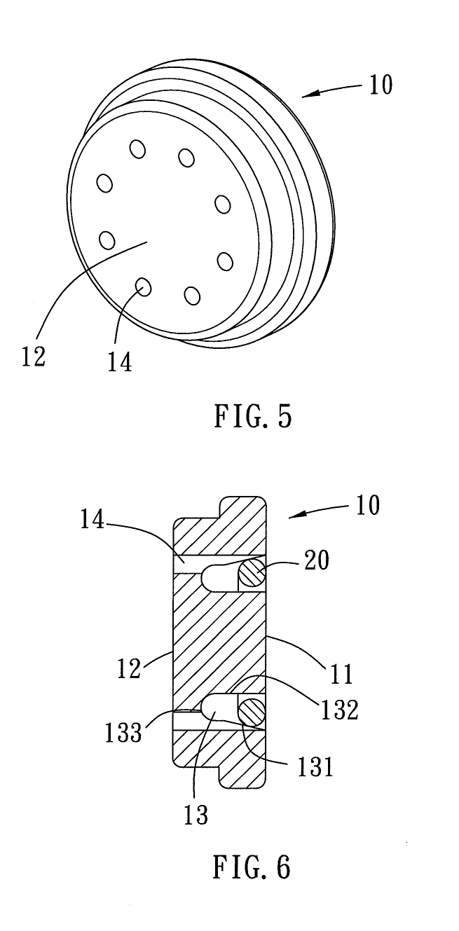

Please refer to FIG. 1 and FIG. 2. The flow rate stabilizer 1 of the present invention is provided to be disposed in a flow way. For example, the flow rate stabilizer 1 can be assembled in a shower nozzle 2, as shown in FIG. 1. The flow rate stabilizer 1 can also be assembled in a faucet, a water pipe, or the like. Please refer to FIG. 3 to FIG. 6, the flow rate stabilizer 1 of a first embodiment of the present invention includes a main body 10 and an elastic ring 20.

The main body 10 has a top surface 11 and bottom surface 12. The top surface 11 is formed with an annular receiving groove 13. The receiving groove 13 extends axially from the top surface 11. The main body 10 is formed with an annular guiding wall 131, an annular abutting wall 132, and an annular bottom wall 133. The receiving groove 13 is defined by the guiding wall 131, the abutting wall 132, and the bottom wall 133. The receiving groove 13 has an opening. The guiding wall 131 extends conically from the opening to the bottom wall 133. The abutting wall 132 extends axially from the opening to the bottom wall 133. A radial distance defined between the guiding wall 131 and the abutting wall 132 is decreased toward the bottom wall 133. In the present embodiment, a diameter of the guiding wall 131 is larger than that of the abutting wall 132. In other words, the abutting wall 132 is located inside of the guiding wall 131. The receiving groove 13 is located between the abutting wall 132 and the guiding wall 131. Preferably, the bottom wall 133 has an arc-shaped cross section.

The main body 10 is further formed with a plurality of penetrating holes 14. Each penetrating hole 14 extends axially and communicates axially with the receiving groove 13. That is, each penetrating hole 14 has an outline which is enclosed in an outline of the receiving groove 13. In other words, outlines of the penetrating holes 14 are located in the outline of the receiving groove 13, and do not pass through the outline of the receiving groove 13. At least a part of a figure of each penetrating hole 14 covers a figure of the guiding wall axially. Preferably, the guiding wall 131 has an outline which is adjacent to the opening touches tangentially with outlines of the penetrating holes 14. That is, the penetrating holes 14 are arranged inside of an outer periphery of the receiving groove 13. Each penetrating hole 14 has a considerable size. Preferably, each penetrating hole 14 has a figure covering both figure of the guiding wall 131 and figure of the bottom wall 133, as shown in FIG. 4. In other words, each penetrating hole 14 may penetrate through both and between the guiding wall 131 and the bottom wall 133.

The elastic ring 20 is received in the receiving groove 13. For anti-shedding purpose, the top surface 11 of the main body or the opening may be covered by other restriction member. The elastic ring 20 abuts the guiding wall 131. The elastic ring 20 is able to move along the guiding wall 131 between a first position and a second position. More particularly, the elastic ring 20 is flexible. The elastic ring 20 can move along the guiding wall 131 axially when the elastic ring 20 is pushed or compressed. The elastic ring 20 has an initial diameter corresponding to the guiding wall 131 when the elastic ring 20 is released from external force, so that the elastic ring 20 has a tendency to move to the first position.

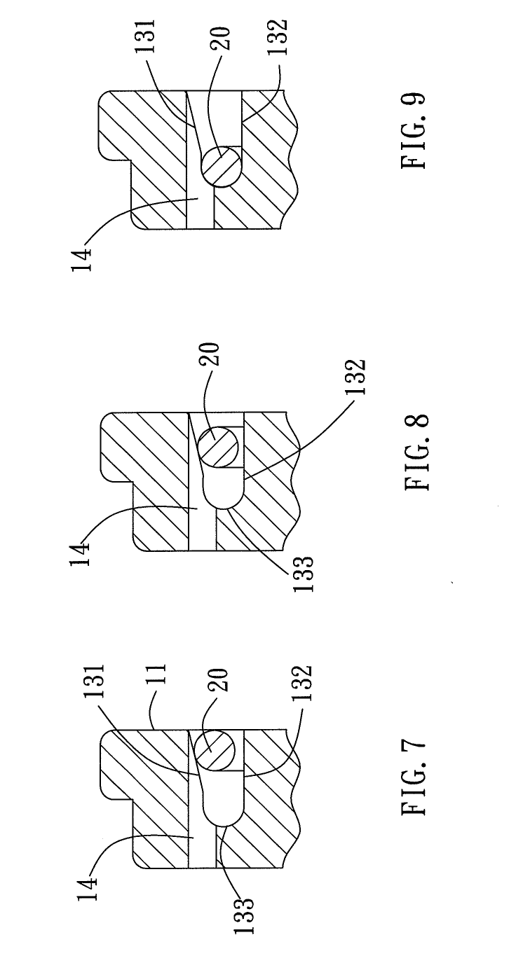

Accordingly, the flow rate stabilizer 1 of the present invention is adapted to be disposed in a flow way. The top surface 11 is made toward the water source. Please refer to FIG. 7 to FIG. 9.

When water is closed or is not entered, or the water pressure is low, the position of the elastic ring is mainly determined by the elastic force of the elastic ring 20. The elastic ring 20 is located at the first position. The elastic ring 20 is adjacent to the opening, as shown in FIG. 7. In this condition, water can pass through an annular gap between the elastic ring 20 and the abutting wall 132. Water then flow out of the receiving groove 13 via the penetrating holes 14.

When water pressure is increased, water would push the elastic ring 20 to move along the guiding wall 131 toward the second position, as shown in FIG. 8. In this condition, water can still pass though an annular gap between the elastic ring 20 and the abutting wall 132. However, the gap here is narrowed. Though water can also pass through the penetrating holes 14 adjacent the opening, the total cross section area of the penetrating holes 14 is still small. Thus, the flow way in the receiving groove 13 is partially obstructed.

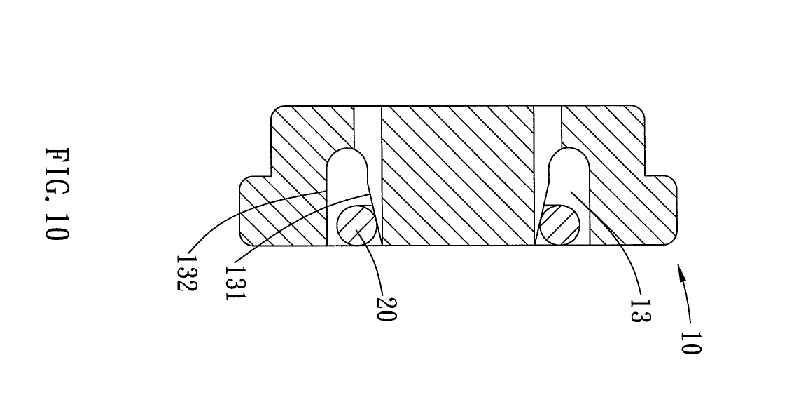

When water pressure is further increased, water would finally push the elastic ring 20 to the second position. The elastic ring 20 would abut against the bottom wall 133, or the elastic ring 20 would even fit with the bottom wall 133 when the bottom wall 133 has an arc-shaped cross section, as shown in FIG. 9. In this condition, the annular gap is totally closed, and the penetrating holes 14 are partially obstructed by the elastic ring also. That is, water can pass though via the penetrating holes 14 only. The flow way in the receiving groove 13 is further obstructed.

To conclude, the position of the elastic ring 20 can be changed by water pressure. Size of the flow way pass through the main body 10 or the receiving groove 13 can be changed also. Thus, increment and decrement of flow rate is minimized. Flow rate is stabilized.

Accordingly, structure of the main body and structure of the elastic ring are simplified. As such, manufacturing and producing the flow rate stabilizer is easier. Durability is well performed also.

Please refer to FIG. 10. In a second embodiment of the present invention, the location of the guiding wall 131 and the abutting wall 132 may be interchanged. More particularly, a diameter of the guiding wall 131 is smaller than that of the abutting wall 132. In other words, the guiding wall 131 is located inside of the abutting wall 132. It is noted that the elastic ring 20 abuts against the guiding wall 13 inwardly. When the elastic ring 20 is moved to the second position, the elastic ring 20 is expanded outwardly. In the second embodiment, the expected functions about water obstruction are still performed as mentioned above.

What is claimed is:

1. A flow rate stabilizer, comprising:
a main body, having a top surface and a bottom surface, the main body being formed with an annular guiding wall, an annular abutting wall, and an annular bottom wall, an annular receiving groove being defined by the guiding wall, the abutting wall, and the bottom wall, the receiving groove extending axially from the top surface, the receiving groove having an opening, the guiding wall extending conically from the opening to the bottom wall, the abutting wall extending axially form the opening to the bottom wall, a radial distance defined between the guiding wall and the abutting wall being decreased toward the bottom wall, the main body being formed with a plurality of penetrating holes, each penetrating hole extending axially, each penetrating hole communicating axially with the receiving groove, at least a part of a figure of each penetrating hole covering a figure of the guiding wall axially;
an elastic ring, received in the receiving groove, the elastic ring abutting the guiding wall, the elastic ring being movable between a first position and a second position along the guiding wall, the elastic ring being adjacent to the opening when the elastic ring is located at the first position, the elastic ring abutting against the bottom wall when the elastic ring is located at the second position, the elastic ring having a tendency to move to the first position.

2. The flow rate stabilizer of claim 1, wherein a diameter of the guiding wall is larger than that of the abutting wall.

3. The flow rate stabilizer of claim 1, wherein a diameter of the guiding wall is smaller than that of the abutting wall.

4. The flow rate stabilizer of claim 1, wherein the bottom wall has an arc-shaped cross section, the elastic ring fits with the bottom wall when the elastic ring is located at the second position.

5. The flow rate stabilizer of claim 2, wherein the bottom wall has an arc-shaped cross section, the elastic ring fits with the bottom wall when the elastic ring is located at the second position.

6. The flow rate stabilizer of claim 3, wherein the bottom wall has an arc-shaped cross section, the elastic ring fits with the bottom wall when the elastic ring is located at the second position.

7. The flow rate stabilizer of claim 1, wherein the guiding wall has an outline which is adjacent to the opening touches tangentially with outlines of the penetrating holes.

8. The flow rate stabilizer of claim 2, wherein the guiding wall has an outline which is adjacent to the opening touches tangentially with outlines of the penetrating holes.

9. The flow rate stabilizer of claim 1, wherein each penetrating hole has a figure covering both figure of the guiding wall and figure of the bottom wall.

10. The flow rate stabilizer of claim 2, wherein each penetrating hole has a figure covering both figure of the guiding wall and figure of the bottom wall.
